(19) United States
(12) Patent Application Publication
(10) Pub. No.: US 2026/0296560 A1
(43) Pub. Date: Oct. 1, 2026

(54) MUDGUARD EXTENSION PLATE

(71) Applicant: Lufeng Dongshen Motorcycle Co., Ltd., Lufeng (CN)

(72) Inventor: WANLIE WU, Lufeng (CN)

(21) Appl. No.: 19/185,321

(22) Filed: Apr. 22, 2025

(30) Foreign Application Priority Data
Mar. 31, 2025 (CN) 202510395251.2

(51) Int. Cl. B62D 25/16

(52) U.S. Cl. CPC B62D 25/163

(57) ABSTRACT

A mudguard extension plate is provided. Which includes a mudguard extension plate body and an auxiliary pressing block; a top of the mudguard extension plate body is provided with a docking groove connected to an external mudguard, and connectors are symmetrically distributed on two sides of the docking groove. A plurality of barbed buckles are symmetrically distributed on two sides of the auxiliary pressing block. The mudguard extension plate body of the present disclosure is installed on an installation carrier with the assistance of double-sided film and is reinforced by the auxiliary pressing block. The reinforcement method is completed by double-sided film and barbed clamping structure, which not only has the physical assistance of double-sided film but also has the barbed clamping structure, rendering it easy, reliable, stable and non-destructive to install on the carrier.

### CROSS-REFERENCE TO RELATED APPLICATIONS

This application claims priority to Chinese Patent Application No. 202510395251.2, filed on Mar. 31, 2025, which is hereby incorporated by reference in its entirety.

### TECHNICAL FIELD

The present disclosure relates to the field of motorcycle accessories technologies, and in particular, to a mudguard extension plate.

### BACKGROUND

Since the birth of motorcycles, various styles of mudguard extension plates have been introduced. Although there are many styles of extension plates, they all belong to the category of damaging installations and require damage to an installation carrier to achieve the purpose of installation. The expensive installation carrier is not damaged, and a lot of effort has paid to design a barbed clamping non-destructive installation structure. The installation difficulty is low, and the installation reliability is stable. Therefore, providing a double-sided clamping non-destructive installation of mudguard extension plate with barbed is one of the urgent technical problems to be solved in this field.

### SUMMARY

The purpose of the present disclosure is to provide an inverted barbed double-sided clamping non-destructive installation mudguard extension plate, which has low installation difficulty, reliable and stable installation, and can achieve non-destructive installation.

In order to achieve the above disclosure objectives, the present disclosure provides the following technical solutions.

The present disclosure provides a mudguard extension plate, including a mudguard extension plate body and an auxiliary pressing block;

a top of the mudguard extension plate body is provided with a docking groove connected to an external mudguard, and connectors are symmetrically distributed on two sides of the docking groove;

a plurality of barbed buckles are symmetrically distributed on two sides of the auxiliary pressing block.

In some embodiments of the present disclosure, a plurality of clamp slots are provided on the connectors.

In some embodiments of the present disclosure, centrifugal membranes are provided in a middle and on two sides of the docking groove.

In some embodiments of the present disclosure, the mudguard extension plate body is connected to the centrifugal membranes through adhesive backing, and the mudguard extension plate body is connected to the external mudguard through adhesive backing.

In some embodiments of the present disclosure, one side of the auxiliary pressing block facing the mudguard extension plate body is provided with the centrifugal membranes.

In some embodiments of the present disclosure, the auxiliary pressing block is connected to the centrifugal membranes through adhesive backing.

In some embodiments of the present disclosure, the mudguard extension plate body matches with the auxiliary pressing block at a connection between the mudguard extension plate body and the auxiliary pressing block.

The beneficial effects of the present disclosure are as follows.

The present disclosure includes a barbed buckle accessory, which adds assistance and sealing of double-sided adhesive tape. The product is installed together with a main component and an accessory. The main component is installed on the installation carrier with the assistance of double-sided film and is reinforced by the accessory. The reinforcement method is completed by double-sided film and barbed clamping structure. With the physical assistance of the double-sided film and the support of the barbed clamping structure, it is easy, reliable, stable, and non-destructive to install on the carrier. The main component does not require hinges, screws, shafts, or pin connections when separated. It is installed and connected through the barbed buckle. The old-fashioned design requires damage to the installation carrier to achieve the installation purpose, which tends to cause fatal damage to the installation carrier. The design of the barbed buckle is unprecedented on the extension plate, and the installation experience and use effect are both excellent.

### BRIEF DESCRIPTION OF DRAWINGS

FIG. 1 is a schematic diagram of an overall structure of a non-destructive installation mudguard extension plate in an embodiment of the present disclosure.

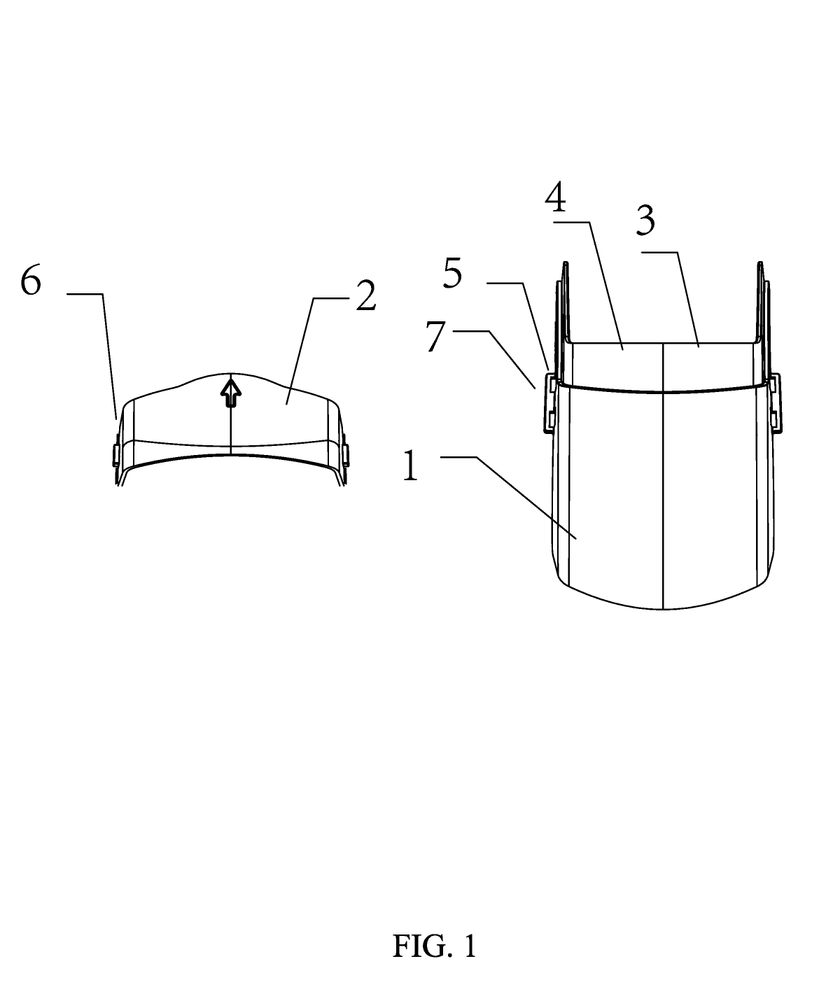

FIG. 2 is a side view of the non-destructive installation mudguard extension plate in an embodiment of the present disclosure.

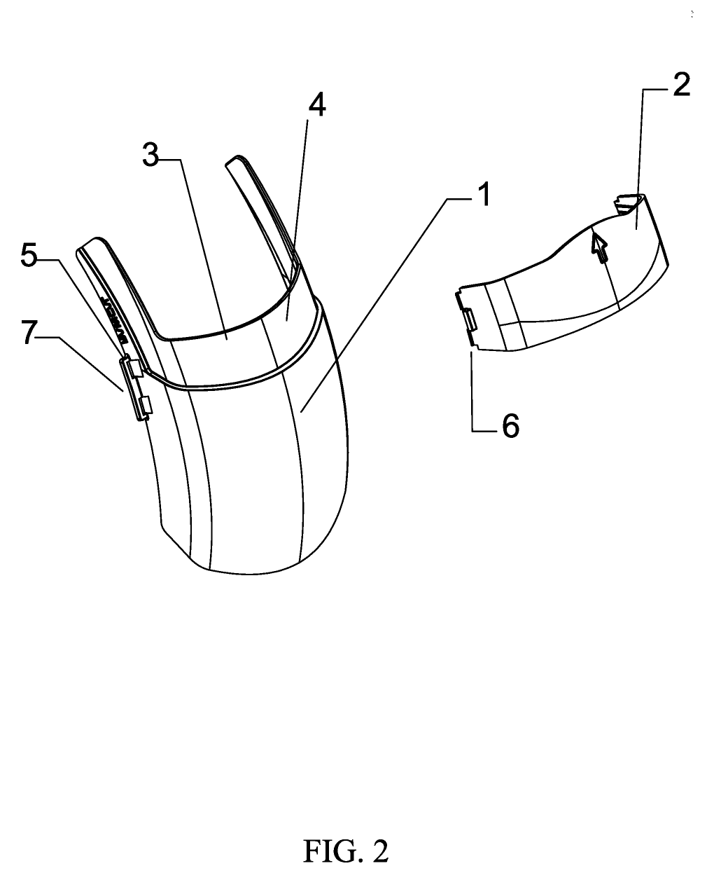

Number reference: 1- mudguard extension plate body; 2- auxiliary pressing block; 3- centrifugal membranes; 4- docking groove; 5- clamp slot; 6- barbed buckle; 7- connector.

### DESCRIPTION OF EMBODIMENTS

The present disclosure provides a non-destructive installation mudguard extension plate, including a mudguard extension plate body and an auxiliary pressing block. A top of the mudguard extension plate body is provided with a docking groove connected to an external mudguard, and connectors are symmetrically distributed on two sides of the docking groove; a plurality of barbed buckles are symmetrically distributed on two sides of the auxiliary pressing block.

In the present disclosure, a plurality of clamp slots are provided on the connectors.

In the present disclosure, centrifugal membranes are provided in a middle and on two sides of the docking groove.

In the present disclosure, the mudguard extension plate body is connected to the centrifugal membranes through adhesive backing, and the mudguard extension plate body is connected to the external mudguard through adhesive backing.

In the present disclosure, one side of the auxiliary pressing block facing the mudguard extension plate body is provided with the centrifugal membranes.

In the present disclosure, the auxiliary pressing block is connected to the centrifugal membranes through adhesive backing.

In the present disclosure, the mudguard extension plate body matches with the auxiliary pressing block at a connection between the mudguard extension plate body and the auxiliary pressing block.

The following provides a detailed explanation of the technical solutions provided by the present disclosure in combination with the embodiments, but they should not be understood as limiting the protection scope of the present disclosure.

A non-destructive installation mudguard extension plate includes a mudguard extension plate body 1 and an auxiliary pressing block 2.

A top of the mudguard extension plate body 1 is provided with a docking groove 4 that connects to an external mudguard, and connectors 7 are symmetrically distributed on two sides of the docking groove 4.

A plurality of barbed buckles 6 are symmetrically distributed on two sides of auxiliary pressing block 2.

A plurality of clamp slots 5 are provided on the connectors 7.

Centrifugal membranes 3 are provided in a middle and on two sides of the docking groove 4.

The mudguard extension plate body 1 is connected to the centrifugal membrane 3 through adhesive backing, and the mudguard extension plate body 1 is connected to the external mudguard through adhesive backing.

One side of the auxiliary pressing block 2 facing the mudguard extension plate body 1 is provided with the centrifugal membranes 3.

The auxiliary pressing block 2 is connected to the centrifugal membranes 3 through adhesive backing.

The mudguard extension plate body 1 matched with the auxiliary pressing block 2 at a connection between the mudguard extension plate body 1 and the auxiliary pressing block 2.

Working principle and use method of the disclosure are as follows: first, a multi-functional foam cleaner or a wet towel is used to deeply clean an installation position and surrounding area; after cleaning, an alcohol cotton is used to clean the installation position for a second time; after cleaning, an adhesive is used to paint the installation surface; after painting, it is dried in the air; a part of the centrifugal membranes 3 is tear in the middle of the mudguard extension plate body 1 from top to bottom so that it can be pulled from this position during installation; right centrifugal membrane 3 is turned from bottom to top and left centrifugal membrane 3 is turned from bottom to top and left, and then the mudguard extension plate body 1 is installed on a motorcycle, and the docking groove 4 matches with a contour of a mudguard on the motorcycle, and it is compacted with hand glue, bubbles are discharged, the centrifugal membranes 3 are slowly tear, the centrifugal membranes 3 are slowing tear, pressed tightly, the bubbles are discharged, and thereby completing an installation of the mudguard extension plate body 1. A part of the centrifugal membranes 3 is removed from the auxiliary pressing block 2, and one side of the barbed buckles 6 is installed onto one side of the connector 7 according to an upward position indicated by the arrow. The centrifugal membranes 3 acts as a sliding force, and then the other side of the barbed buckles 6 is installed onto the other side of the connectors 7. The centrifugal membranes 3 is removed, pressed firmly, and thereby completing the installation of the auxiliary pressing block 2, thus the installation of the non-destructive installation of the mudguard extension plate is completed.

From the above embodiments, the present disclosure provides a non-destructive installation mudguard extension plate. The present disclosure adds a barbed buckle accessory, which enhances the assistance and sealing of double-sided adhesive tape. It is installed together with a main component (mudguard extension plate body) and an accessory (auxiliary pressing block). The main component is installed on the installation carrier with double-sided film assistance, and the accessory is used to reinforce it. The reinforcement method is completed by double-sided film and barbed clamping structure. With the physical assistance of the double-sided film and the support of the barbed clamping structure, it is easy, reliable, stable, and non-destructive to install on the carrier. The main accessories without the need for hinges, screws, shafts, or pin connections when separated. It is connected through the barbed clamping installation. The old-fashioned design requires damage to the installation carrier to achieve the installation purpose, and the protection range is small. And it is easy to cause fatal damage to the installation carrier. The design of the barbed buckle is unprecedented on the extension plate, and the installation experience and use effect are both excellent.

The above is only the preferred embodiment of the present disclosure. It should be noted that for those skilled in the art, several improvements and embellishments can be made without departing from the principles of the present disclosure. These improvements and embellishments should also be considered as the protection scope of the present disclosure.

What is claimed is:

1. A mudguard extension plate, comprising a mudguard extension plate body and an auxiliary pressing block;
a top of the mudguard extension plate body is provided with a docking groove connected to an external mudguard, and connectors are symmetrically distributed on two sides of the docking groove;
a plurality of barbed buckles are symmetrically distributed on two sides of the auxiliary pressing block.

2. The mudguard extension plate according to claim 1, wherein a plurality of clamp slots are provided on the connectors.

3. The mudguard extension plate according to claim 1, wherein centrifugal membranes are provided in a middle and on two sides of the docking groove.

4. The mudguard extension plate according to claim 3, wherein the mudguard extension plate body is connected to the centrifugal membranes through adhesive backing, and the mudguard extension plate body is connected to the external mudguard through adhesive backing.

5. The mudguard extension plate according to claim 1, wherein one side of the auxiliary pressing block facing the mudguard extension plate body is provided with the centrifugal membranes.

6. The mudguard extension plate according to claim 5, wherein the auxiliary pressing block is connected to the centrifugal membranes through adhesive backing.

7. The mudguard extension plate according to claim 1, wherein the mudguard extension plate body matches with the auxiliary pressing block at a connection between the mudguard extension plate body and the auxiliary pressing block.
